(19) United States
(12) Patent Application Publication
(10) Pub. No.: US 2021/0029499 A1
(43) Pub. Date: Jan. 28, 2021

(54) POWER ADAPTER

(71) Applicant: Ximplar Limited, Hong Kong (HK)

(72) Inventors: Pui Tong Paul LEE, Hong Kong (HK); Ka Kui CHENG, Hong Kong (HK); Kin Hin WONG, Hong Kong (HK)

(21) Appl. No.: 16/935,235

(22) Filed: Jul. 22, 2020

Related U.S. Application Data
(60) Provisional application No. 62/877,321, filed on Jul. 23, 2019.

(51) Int. Cl. H04W 4/029; H04B 5/00; G08B 25/10

(52) U.S. Cl. CPC H04W 4/029; G16Y 40/10; G08B 25/10; H04B 5/0062

(57) ABSTRACT

The present invention provides a power adapter comprising a positioning module for determining its location based on GPS, Wi-Fi access point fingerprinting, RFID, NFC and/or other positioning technologies; sensors for collecting operational/environmental data, including but not limited to air quality, electric current usage, temperature, humidity, altitude, illuminance, infrared radiation, ultraviolet radiation and nuclear radiation; a communication module configured to communicate wirelessly via protocols of various technology standards, including but not limited to cellular (3G/4G etc.), Wi-Fi, Bluetooth and NB-IoT; and a recording module and recognizing module for recording and identifying suspects of surrounding area. With the built-in location tracking, data collection and wireless communication functions, the power adapter of the present invention allows the extension of internet connectivity to existing non-internet-enabled devices without significant infrastructure modifications.

### CROSS-REFERENCES TO RELATED APPLICATIONS

This application claims priority to the U.S. provisional patent application No. 62/877,321 filed on Jul. 23, 2019, and the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a power adapter with built-in location tracking, data collection and wireless communication functions.

### BACKGROUND

There are needs for tacking the locations of various devices or equipment deployed in various environments. For example, operations of life-sustaining or life-supporting medical devices are required to be tracked contiguously to ensure that they can be promptly located the moment failure occurs to avoid serious, adverse health consequences. It is also desirable to have some high value assets being tracked for preventing theft or loss.

Payment terminal such as credit card terminal, contactless terminal or point of sale (POS) device normally focused on the security of the transaction, the actual implementation of the security procedure often relies on an external surveillance system that is separately located and maintained. Any failure to the surveillance system may expose the payment terminal in the risk. Moreover, there are over 7 million businesses in the U.S. accepting credit cards. This is a huge market to the banks but also a big risk for the banks too. It is a challenge to the banks proving or making sure all their merchant customers are using their terminal legally. There have been real cases where a store claiming itself to be an antique store but actually was selling Nazi memorabilia, or a pharmacy that was selling narcotics. Currently the banks rely on physical visits and constant online monitoring to ensure compliance. But these efforts are expensive and ineffective at best.

Furthermore, with the evolution of Internet of Things (IoT) technologies, it is also becoming increasingly important to determine the locations of devices and monitor their operational/environmental conditions. It is also desirable to extend such connectivity to existing non-internet-enabled appliances without significant infrastructure modifications.

Various solutions have been developed for tracking locations. Satellite tracking systems, such as the Global Positioning System (GPS), are being used to provide location determination. For example, U.S. Pat. No. 9,503,846B2 discloses certain embedded location tracking systems for tracking sports equipment by retrofitting GPS tags in the equipment of interest. However, such types of tracking systems may suffer from the drawbacks of requiring maintenance such as recharging or replacing of batteries and inaccuracy of position information by GPS under indoor environments such as factories, shopping malls and hospitals.

### SUMMARY OF THE INVENTION

It is an objective of the present invention to provide a power adapter with built-in position tracking, data collection and wireless communication functions. It is a further objective of the present invention to allow the extension of internet connectivity to existing non-internet-enabled devices without significant infrastructure modifications. It is another objective of the present invention to provide a power adapter equipped with positioning reader designed to read the content of a compatible electronic tag of a specially configured wall socket for critical applications such as medical life-support equipment operation monitoring. It is yet another objective of the present invention to provide a power adapter equipped with a hidden module designed to monitor ambient conditions for the safety of the transaction such as payment operations.

In accordance to one aspect of the present invention, the power adapter comprises a positioning module for determining its location based on GPS, Wi-Fi access point fingerprinting, Radio Frequency Identification (RFID), Near Field Communication (NFC) and/or other positioning technologies.

In accordance to another aspect of the present invention, the power adapter comprises sensors for collecting operational/environmental data, including but not limited to air quality, electric current usage, temperature, humidity, altitude, illuminance, infrared radiation, ultraviolet radiation and nuclear radiation.

In accordance to another aspect of the present invention, the power adapter comprises a communication module for communicate wirelessly via protocols of various technology standards, including but not limited to cellular (3G/4G, etc.), Wi-Fi, Bluetooth and narrowband IoT (NB-IoT). Through the wireless communication, the power adapter can report the collected data as well as receive commands from a control center via a network. The commands may include but not limited to turning different sensors on and off, changing the parameters of data collection and allowing/stopping electricity flow to the plugged-in equipment.

In accordance to yet another aspect of the present invention, the power adapter comprises an audio and/or video recording device for recording the sound and/or video of its surrounding, and a recognizing module for identifying suspects from the recorded audio and/or video. The power adapter can store the recorded audio and/or video in local non-transient memory or transmit the recorded audio and/or video to a remote control center, and report any identified suspect.

### BRIEF DESCRIPTION OF THE DRAWINGS

Embodiments of the invention are described in more detail hereinafter with reference to the drawings, in which:

FIG. 1 depicts a block diagram of a power adapter according to the present invention;

FIG. 2 depicts a power adapter to be used with a music equipment according to one embodiment of the present invention;

FIG. 3 depicts a power adapter to be used with a mobile aerial work platform according to one embodiment of the present invention;

FIG. 4 depicts a power adapter to be used with a refrigerator according to one embodiment of the present invention;

FIG. 5 depicts a power adapter to be used with an air conditioner according to one embodiment of the present invention;

FIG. 6 depicts a power adapter to be used with a medical device according to one embodiment of the present invention;

FIG. 7 depicts a power adapter to be used with an outdoor heat lamp according to one embodiment of the present invention;

FIG. 8 depicts a power adapter to be used with a payment terminal according to one embodiment of the present invention;

FIG. 9 depicts a power adapter to be used with a payment terminal according to another embodiment of the present invention; and

FIG. 10 depicts a power adapter to be used with a payment terminal according to yet another embodiment of the present invention.

### DETAILED DESCRIPTION

It is to be understood that the power adapter and related system for use is not limited in its application to the details of construction and the arrangement of components set forth in the following description or illustrated in the drawings. The embodiments were chosen and described in order to best explain the principles of the invention and its practical application, thereby enable others skilled in the art to understand the invention for various embodiments and with various modifications that are suited to the particular use contemplated. Also, it is to be understood that the phraseology and terminology used herein is for the purpose of description and should not be regarded as limited. The use of “including”, “comprising” or “having” and variations thereof herein is meant to encompass the items listed thereafter and equivalents thereof as well as additional items. Unless limited otherwise, the terms “connected”, “coupled” and variations thereof are used broadly and encompass direct and indirect connections, couplings, and mountings. In addition, the terms “connected” and “coupled” and variations thereof are not restricted to physical or mechanical connections or couplings. The words “outlet” and “receptacle” are used interchangeably in this disclosure.

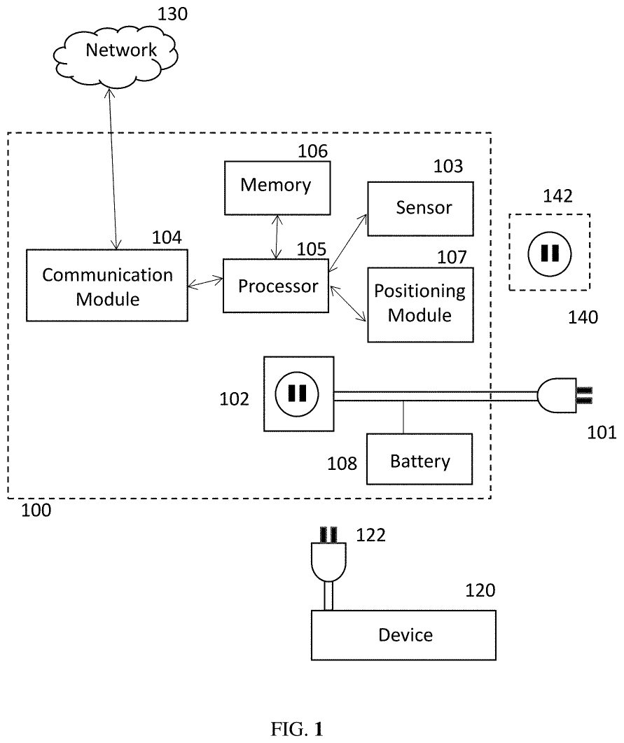

FIG. 1 depicts a block diagram of a power adapter 100 according to the present invention. The power adapter 100 may be a standard AC power adapter or a DC power adapter to be used with a device 120. It should be appreciated that the device 120 may be any types of equipment including, but not limited to computers, home appliances, industrial equipment, laboratory equipment, medical equipment. The power adapter 100 may comprise a casing, a power input plug 101, a power output socket 102. The power output socket 102 may be configured to engage with a power input plug 122 of the device 120. The power input plug 101 may be configured to engage with a power output socket 142 of a power source 140, which may be, for example, a municipal utility power supply source.

The power adapter 100 may further comprise a positioning module 107 configured to detect and receive one or more location tracking signals; a processor 105 configured to process the location tracking signals to determine a location of the device 120.

The power adapter 100 may further comprise a sensor module 103 configured to measure operational/environmental parameters and feed the measured operational/environmental parameters to the processor 105. The processer 105 may be further configured to process the measured operational/environmental parameters to compute one or more operational/environmental data of the device 120.

The power adapter 100 may further comprise a communication module 104 connected to a remote control center via a network 130. The processor 105 may be further configured to transmit the determined location and computed operational/environmental data to the communication module 104 for exchanging data and commands with the remote control center.

Alternatively, the communication module 104 may also be configured to detect and receive one or more location tracking signals and feed the detected and received location tracking signals to the processor 105.

Optionally, the power adapter may further comprise a memory 106; and the processor 105 may be further configured to transmit the computed location and operational/environmental data to the memory 106 for temporary storage.

The power adapter 100 may further comprise a rechargeable battery 108 which is recharged whenever the power adapter is connected to a power source and configured to provide power for continued operation of equipment when the power adapter is not in connection with a power source, for example, during transportation.

The location tracking signals to be detected by the positioning module 107 or communication module 104 may include, but not limited to, GPS signals, Wi-Fi signals, RFID signals and NFC signals.

The communication module 104 may be configured to communicate wirelessly via protocols of various technology standards, including but not limited to cellular, Wi-Fi, Bluetooth and NB-IoT.

The operational/environmental data measured by the sensor module 103 may include, but not limited to, electric current usage, temperature, humidity, illuminance, air quality, altitude, infrared radiation, ultraviolet radiation and nuclear radiation.

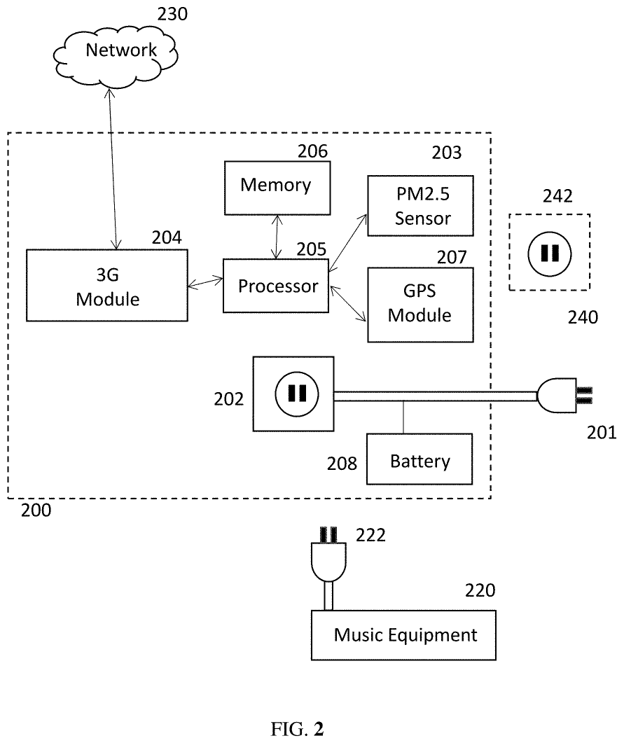

FIG. 2 depicts a power adapter 200 according to one embodiment of the present invention. The power adapter 200 may be used with a device 220 which is a music equipment in this illustrative example. The power adapter 200 may comprise a casing, a power input plug 201, a power output socket 202. The power output socket 202 may be configured to engage with a power input plug 222 of the music equipment 220. The power input plug 201 may be configured to engage with a power output socket 242 of a power source 240.

The power adapter 200 may further comprise a PM2.5 sensor module 203 for measuring the air quality of the working environment of the music equipment 220; a GPS module 207 for tracking location of the music equipment 220; a processor 205 for computing the location and the air quality of the working environment of the music equipment 220; a 3G communication module 204 for exchanging data and commands with a remote center via a network 230; a memory 206 for temporarily storing the computed location and air quality data; and a rechargeable battery 208.

The PM2.5 sensor module 203 may be configured to radiate suspending particles in the air in proximity of the music equipment 220 with a laser light, measure the laser scattering change with time, and feed the measured values to the processor 205 to compute the PM2.5 dust concentrations in proximity of the music equipment 220.

The GPS module 207 may be configured to receive GPS signals from GPS satellites and feed the received GPS signals to the processor 205. The processor 205 may be further configured to utilize at least one of triangulation and trilateration based on the received GPS signals to determine the location of the music equipment 220.

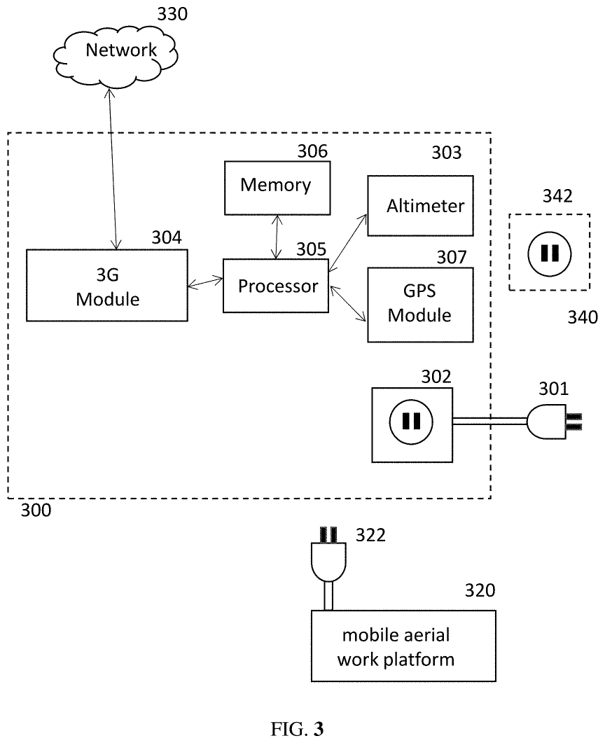

FIG. 3 depicts a power adapter 300 according to another embodiment of the present invention. The power adapter 300 may be used with a device 320 which is a mobile aerial work platform in this illustrative example. The power adapter 300 may comprise a casing, a power input plug 301, a power output socket 302. The power output socket 302 may be configured to engage with a power input plug 322 of the mobile aerial work platform 320. The power input plug 301 may be configured to engage with a power output socket 342 of a power source 340.

The power adapter 300 may further comprise an altimeter 303 for measuring the altitude of the mobile aerial work platform 320; a GPS module 307 for tracking location of the mobile aerial work platform 320; a processor 305 for computing the location and the altitude of the mobile aerial work platform 320; a 3G communication module 304 for exchanging data and commands with a remote center via a network 330; and a memory 306 for temporarily storing the computed location and altitude data.

The altimeter 303 may be configured for measuring the atmospheric pressure and feed the measured atmospheric pressure value to the processor 305 to compute the altitude of the mobile aerial work platform 320.

The GPS module 307 may be configured to receive GPS signals from GPS satellites and feed the received GPS signals to the processor 305. The processor 305 may be further configured to utilize at least one of triangulation and trilateration based on the received GPS signals to determine the location of the mobile aerial work platform 320.

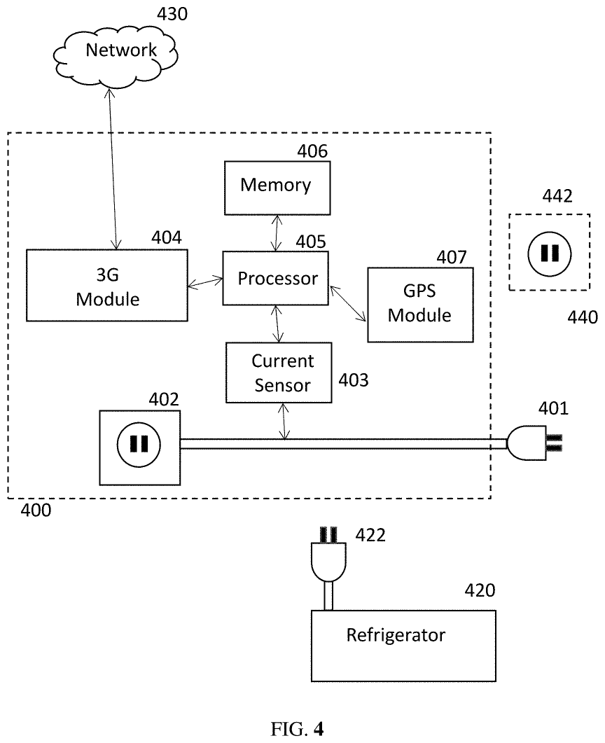

FIG. 4 depicts a power adapter 400 according to another embodiment of the present invention. The power adapter 400 may be used with a device 420 which is a refrigerator in this illustrative example. The power adapter 400 may comprise a casing, a power input plug 401, a power output socket 402. The power output socket 402 may be configured to engage with a power input plug 422 of the refrigerator 420. The power input plug 401 may be configured to engage with a power output socket 442 of a power source 440.

The power adapter 400 may further comprise a current sensor 403 coupled to the power output socket 402; a GPS module 407 for tracking location of the refrigerator 420; a processor 405 for computing the location and the current usage of the refrigerator 420; a 3G communication module 404 for exchanging data and commands with a remote center via a network 430; and a memory 406 for temporarily storing the computed location and current usage data.

The current sensor 403 may be configured for measuring the current at the output power socket 402 and feed the measured value to the processor 405 to compute the current usage of the refrigerator 420.

The GPS module 407 may be configured to receive GPS signals from GPS satellites and feed the received GPS signals to the processor 405. The processor 405 may be further configured to utilize at least one of triangulation and trilateration based on the received GPS signals to determine the location of the refrigerator 420.

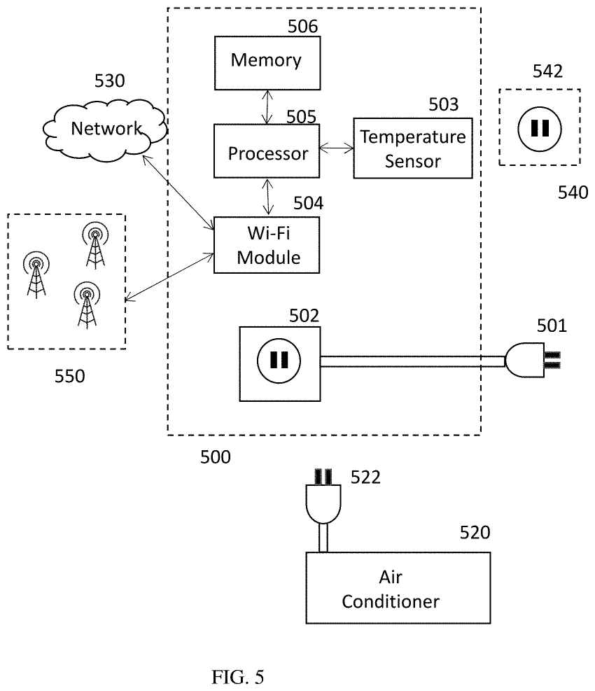

FIG. 5 depicts a power adapter 500 according to another embodiment of the present invention. The power adapter 500 may be used with a device 520 which is an air conditioner in this illustrative example. The power adapter 500 may comprise a casing, a power input plug 501, a power output socket 502. The power output socket 502 may be configured to engage with a power input plug 522 of the air conditioner 520. The power input plug 501 may be configured to engage with a power output socket 542 of a power source 540.

The power adapter 500 may further comprise a temperature sensor 503 for measuring the working temperature of the air conditioner 520; a Wi-Fi module 504 for tracking location and exchanging data and commands with a remote center via a network 530; a processor 505 for computing the location and the working temperature of the air conditioner 520; and a memory 506 for temporarily storing the computed location and working temperature data.

The Wi-Fi module 504 may be configured to receive access point data, including but not limit to Received Signal Strength Indicator (RSSI) value, Service Set Identifier (SSID) and Media Access Control (MAC) address from a plurality of access points 550 in range and feed the access point data to the processor 505. The processor 505 may be configured to compare the received access point data to a fingerprint database of access points with known positions to return a closest matched result to determine the location of the air conditioner 520.

The temperature sensor 503 may be one of, but not limited to, thermal couple, thermistor and semiconductor-based temperature sensors, configured to measure temperature change and feed the measured value to the processor 505 to compute the working temperature of the air conditioner 520.

In accordance to other embodiments of the present invention, the power adapter may include one or more of motion sensor, light sensor, acoustic sensor, sound meter, and moisture/water detector for various domestic, commercial, and industrial applications such as in premises security monitoring, live event hosting and management, laboratory and medical facility monitoring. An ordinarily skilled person in the art should appreciate that sensors of different functionalities and configurations can be incorporated in the power adapter without deviating from the spirit of the present invention and undue experimentation.

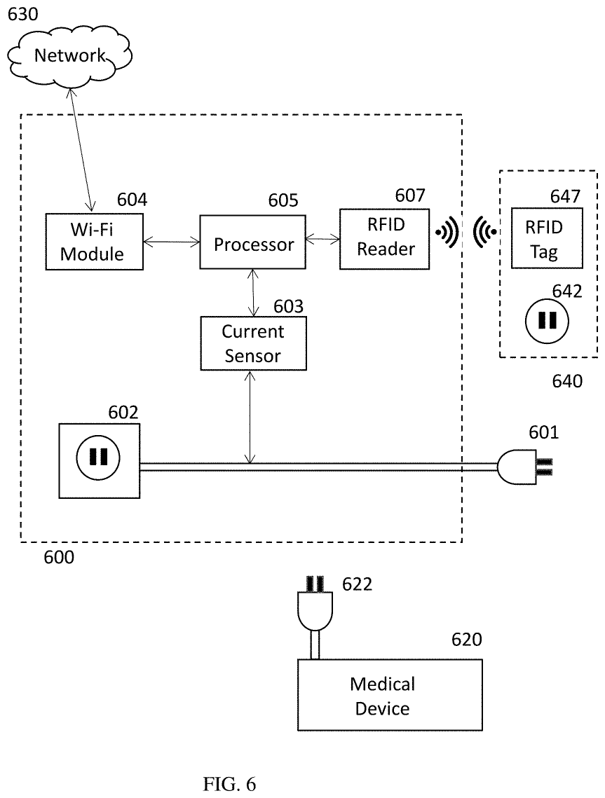

FIG. 6 depicts a power adapter 600 according to another embodiment of the present invention. The power adapter 600 may be used with a device 620 which is a medical device in this illustrative example. The power adapter 600 may comprise a casing, a power input plug 601, a power output socket 602. The power output socket 602 may be configured to engage with a power input plug 622 of the medical device 620. The power input plug 601 may be configured to engage with a power output socket 642 of a power source 640.

The power adapter 600 may further comprise a current sensor 603 connected to the power output socket 602; a RFID reader 607; a processor 605 for computing the location and monitoring the operation status of the medical device 620; a Wi-Fi module 604 for exchanging data and commands with a remote center via a network 630; and a memory 606 for temporarily storing the computed location and operation status data.

The RFID reader 607 may be configured to detect an identification number from a RFID tag 647 installed in the power source 640 and feed the identification number to the processor 605. The processor 605 may be configured to compare the received identification number to a database of identification numbers with known positions to return a closest matched result to determine the location of the medical device 620.

Optionally, the Wi-Fi module 604 may be configured to receive access point data, including but not limit to Received Signal Strength Indicator (RSSI) value, Service Set Identifier (SSID) and Media Access Control (MAC) address from a plurality of access points 650 in range and feed the access point data to the processor 605. The processor 605 may be configured to compare the received access point data to a fingerprint database of access points with known positions to return a closest matched result to determine the location of the medical device 620.

The current sensor 603 may be configured for measuring the current at the output power socket 602 and feed the measured current value to the processor 605 to monitor the operation status of the medical device 620.

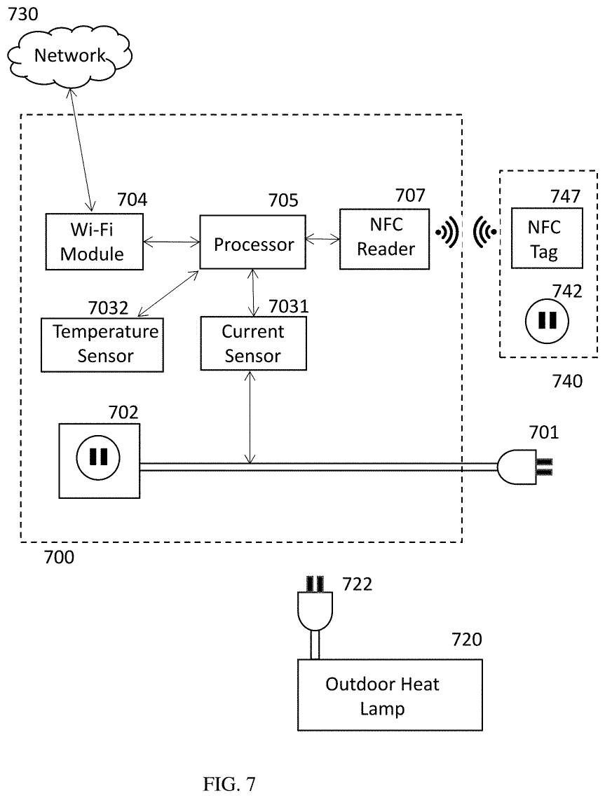

FIG. 7 depicts a power adapter 700 according to another embodiment of the present invention. The power adapter 700 may be used with a device 720 which is an outdoor heat lamp in this illustrative example. The power adapter 700 may comprise a casing, a power input plug 701, a power output socket 702. The power output socket 702 may be configured to engage with a power input plug 722 of the outdoor heat lamp 720. The power input plug 701 may be configured to engage with a power output socket 742 of a power source 740.

The power adapter 700 may further comprise a current sensor 7031 connected to the power output socket 702; a temperature sensor 7032; an NFC reader 707; a processor 705 for computing the location and monitoring the operation status of the outdoor heat lamp 720; a Wi-Fi module 704 for exchanging data and commands with a remote center via a network 730; and a memory 706 for temporarily storing the computed location and operation status data.

The NFC reader 707 may be configured to detect an identification number from a NFC tag 747 installed in the power source 740 and feed the identification number to the processor 705. The processor 705 may be configured to compare the received identification number to a database of identification numbers with known positions to return a closest matched result to determine the location of the outdoor heat lamp 720.

Optionally, the Wi-Fi module 704 may be configured to receive access point data from a plurality of access points 750 in range and feed the access point data to the processor 705. The processor 705 may be configured to compare the received access point data to a fingerprint database of access points with known positions to return a closest match to determine the location of the outdoor heat lamp 720.

The current sensor 7031 may be configured for measuring the current at the output power socket 702 and feed the measured value to the processor 705 to monitor the current consumption of the outdoor heat lamp 720.

The temperature sensor 703 may be configured to measure the temperature change and feed the measured value to the processor 705 to compute the working temperature of the outdoor heat lamp 720.

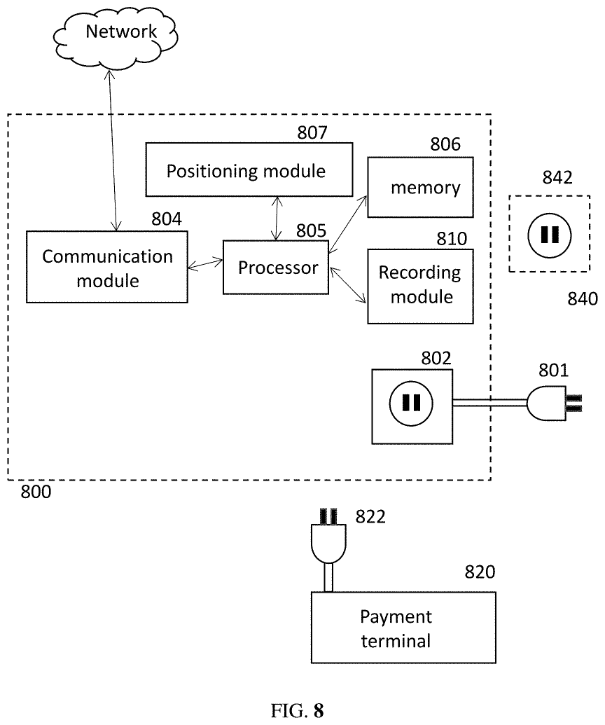

FIG. 8 depicts a power adapter 800 according to another embodiment of the present invention. In this embodiment, the power adapter 800 is used with a payment terminal 820 and comprises a casing, a power input plug 801 and a power output socket 802. The power output socket 802 is configured to engage with a power input plug 822 of the payment terminal 820. The power input plug 801 is configured to engage with a power output socket 842 of a power source 840.

The payment terminal 820 is configured to provide a mean of payment transaction, which includes but not limited to a point of sale (POS) device and a credit card terminal.

The power adapter 800 may further comprise a recording module 810, a positioning module 807 and a processor 805. The recording module 810 is configured for recording audio, video, or both of its surrounding, and can be a microphone or a camera.

As aforementioned, the positioning module 807 may be a GPS module, Wi-Fi module, a RFID reader or an NFC reader, which is configured for detecting and/or receiving location tracking signals. The processor 805 may be configured to process the location tracking signals to determine a location of the device.

The power adapter 800 may further comprise a non-transient memory 806 that allows the processor 805 to store the recorded audio and video temporarily. Alternatively, the power adapter 800 may further comprise a communication module 804 that is configured to exchange data and commands with a remote control center, and store the recorded audio or video to an external storage via a network.

Accordingly, as described in the background section of the present disclosure, the bank desire to monitor and ensure the business transactions of their clients are all legitimate. The recording module 810 of the power adapter 800 is able to record the conversation in the ship of the associated transactions via the payment terminal. The recorded conversation may be uploaded to the remote control center and store to the external storage.

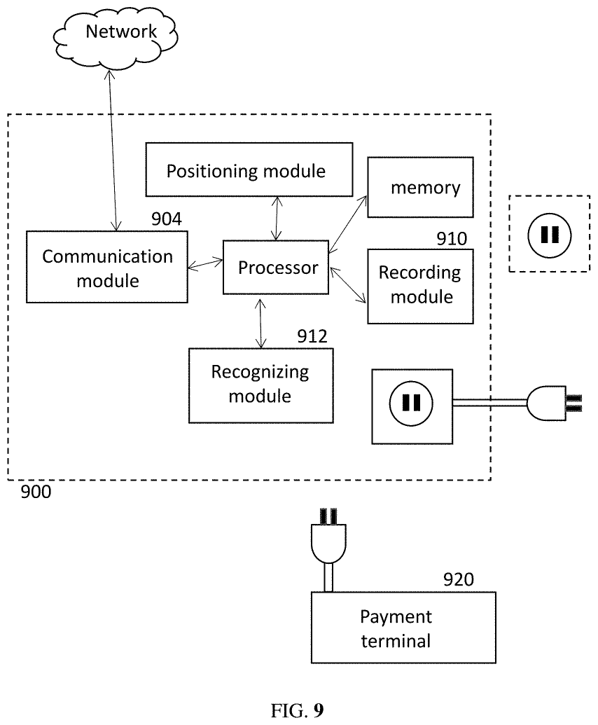

FIG. 9 depicts a power adapter 900 to be used with a payment terminal 920 according to another embodiment of the present invention. In this embodiment, the power adapter 900 further comprises a recognizing module 912 configured to identify suspect from the recorded audio or video.

The recognizing module 912 may be an Automatic Speech Recognition (ASR) system that is able to recognize and transcribe spoken language into text. In one embodiment, the recognizing module 912 can be triggered by certain keywords while a recording module 910 is continuously recording the ambient audio, and convert a conversation into text. The keywords used for triggering the recognizing module 912 are predetermined and are considered to be keywords related to suspected illegal activities.

In another embodiment, the recognizing module 912 can also be a facial recognizing module configured identify suspect from the recorded video.

The power adapter 900 may further comprise a communication module 904 configured to report the identified suspect to a remote control center or store the video of identified suspect to an external storage via a network.

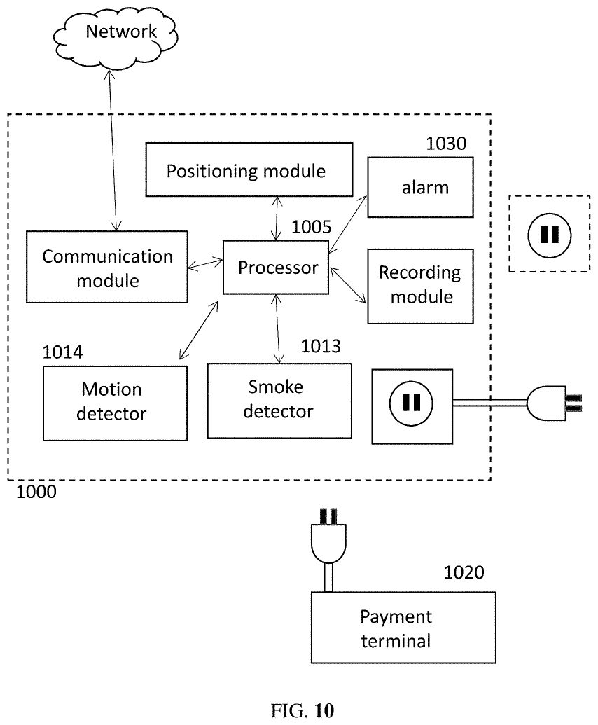

FIG. 10 depicts a power adapter 1000 in accordance with another exemplary embodiment of the present invention. In this embodiment, in order to secure the payment terminal 1020, the power adapter 1000 may further comprise a smoke detector 1013 and a motion detector 1014 connected to a processor 1005. The smoke detector 1013 is configured to sense excessive smoke in its ambient area. The motion detector 1014 is configured to detect any movement in its detection range area.

The power adapter 1000 may further comprise an emergency alarm 1030. The emergency alarm 1030 is configured for noticing the user or transmitting notice remotely to a remote control center. For example, the emergency alarm 1030 is triggered when the smoke detector 1013 detects excessive smoke, unexpected motion detected by the motion detector 1014, a short circuit of the power adapter 1000, or a blackout.

The emergency alarm 1030 may be any format such as a buzzer, a flash light or a signal transmitter.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

What is claimed is:

1. A power adapter to be used with a device, comprising a casing, a power input plug configured to engage with a power output socket of a power source, and a power output socket configured to engage with a power input plug of the device, the power adapter comprising:
a positioning module configured to detect and receive one or more location tracking signals;
a recording module configured to record audio, video or both of its surrounding;
a recognizing module configured to identify suspects from the recorded audio, video or both; and
a processor configured to process the location tracking signals to determine a location of the device.

2. The power adapter of claim 1, further comprising a communication module configured to exchange data and commands with a remote control center, and store the recorded audio, video and records of the identified suspects to an external storage via a network.

3. The power adapter of claim 1, further comprising a sensor module configured to measure one or more operational/environmental parameters and feed the measured operational/environmental parameters to the processor.

4. The power adapter of claim 3, wherein the processor is further configured to transmit through the communication module the determined location of the device and computed operational/environmental data to the remote control center.

5. The power adapter of claim 3, further comprising a memory; wherein the processor is further configured to transmit the computed location operational/environmental data, and the recorded audio, video or both to the memory for temporary storage.

6. The power adapter of claim 1, further comprising a rechargeable battery configured to be recharged when the power adapter is connected to a power source and configured to provide power for continued operation when the power adapter is not in connection with a power source.

7. The power adapter of claim 1, wherein
the positioning module is a Global Positioning System (GPS) module configured to receive one or more GPS signals from one or more GPS satellites and feed the GPS signals to the processor; and
the processor is configured to utilize at least one of triangulation and trilateration based on the received GPS signals to determine the location of the device.

8. The power adapter of claim 1, wherein
the positioning module is a Wi-Fi module configured to receive one or more access point data from a plurality of network access points in range and feed the access point data to the processor; and
the processor is configured to compare the received access point data to a fingerprint database of access points with known positions to return a closest matched result to determine the location of the device.

9. The power adapter of claim 1, wherein
the positioning module is a Radio Frequency Identification (RFID) reader configured to receive an identification number from a RFID tag installed in the power source and feed the identification number to the processor; and
the processor is configured to compare the received identification number to a database of identification numbers with known positions to return a closest matched result to determine the location of the device.

10. The power adapter of claim 1, wherein
the positioning module is a Near Filed Communication (NFC) reader configured to receive an identification number from an NFC tag installed in the power source and feed the identification number to the processor; and
the processor is configured to compare the received identification number to a database of identification numbers with known positions to return a closest matched result to determine the location of the device.

11. The power adapter of claim 3, wherein the sensor module is a PM2.5 sensor configured to radiate suspending particles in the air with a laser light, measure the laser scattering change with time and feed the measured laser scattering change to the processor to compute a PM2.5 dust concentrations in proximity of the device.

12. The power adapter of claim 3, wherein the sensor module is an altimeter configured to measure an atmospheric pressure and feed the measured atmospheric pressure to the processor to compute an altitude of the device.

13. The power adapter of claim 3, wherein the sensor module is a current sensor connected to the power output socket and configured to measure a current at the output power socket and feed the measured current to the processor to compute a current usage of the device.

14. The power adapter of claim 3, wherein the sensor module is a temperature sensor configured to measure a temperature change and feed the measured temperature change to the processor to compute a working temperature of the device.

15. The power adapter of claim 1, wherein the communication module is a cellular communication module, Wi-Fi communication module, Bluetooth communication module or a narrowband IoT (NB-IoT) communication module.

16. The power adapter of claim 1, wherein the device is a payment terminal.

17. The power adapter of claim 19, wherein the payment terminal is a credit card terminal or a point of sale device.

18. The power adapter of claim 1, wherein the recording module is a microphone or a camera.

19. The power adapter of claim 3, wherein the sensor module is a smoke detector or a motion detector.

20. The power adapter of claim 1, further comprises an emergency alarm, wherein the emergency alarm is triggered when there is excessive smoke detected by the smoke detector detects, unexpected motion detected by the motion detector detects, a short circuit of the power adapter or a blackout.
